(19) United States
(12) Patent Application Publication
(10) Pub. No.: US 2025/0322092 A1
(43) Pub. Date: Oct. 16, 2025

(54) TASK CONTROL IN GENERATIVE ARTIFICIAL INTELLIGENCE BASED ON PROMPT PROCESSING UNITS

(71) Applicant: Cisco Technology, Inc., San Jose, CA (US)

(72) Inventors: Chiara Troiani, Cheseaux-sur-Lausanne (CH); Marcelo Yannuzzi, Nuvilly (CH); Jean Andrei Diaconu, Gaillard (FR); Hervé Muyal, Gland (CH)

(73) Assignee: Cisco Technology, Inc., San Jose, CA (US)

(21) Appl. No.: 18/931,535

(22) Filed: Oct. 30, 2024

Related U.S. Application Data
(60) Provisional application No. 63/633,438, filed on Apr. 12, 2024.

(51) Int. Cl. G06F 21/62; G06F 40/205; G06F 40/40

(52) U.S. Cl. CPC G06F 21/6218; G06F 40/205; G06F 40/40

(57) ABSTRACT

In one implementation, a device may identify a type of task and its context indicated by a prompt sent by a user for input to a language model. The device may authorize the prompt for input to the language model based on the type of task and its context. The device may make a determination as to whether a response of the language model to the prompt is authorized to be returned to the user based on the response, the type of task, and its context. The device may prevent the response from being returned to the user when the determination indicates that the response is not authorized to be returned.

### RELATED APPLICATION

This application claims priority to U.S. Prov. Appl. Ser. No. 63/633,438, filed Apr. 12, 2024, for TASK CONTROL IN GENERATIVE ARTIFICIAL INTELLIGENCE BASED ON PROMPT PROCESSING UNITS, by Troiani, et al., the contents of which are incorporated herein by reference.

### TECHNICAL FIELD

The present disclosure relates generally to computer networks, and, more particularly, to task control in generative artificial intelligence (AI) based on prompt processing units (PPUs).

### BACKGROUND

The use of generative artificial intelligence (AI) is helping to augment productivity across enterprises. Indeed, enterprises are increasingly using pre-trained Large Language Models (LLMs), fine-tuned models, and agents offered or hosted by third party providers, to support a myriad of enterprise tasks. These models are usually served as part of larger systems that may also include pre-integrated application programming interfaces (APIs) and/or tools to orchestrate, execute, and chain various tasks before responding to a query carried in a prompt.

Although many enterprises aim to leverage generative AI more in the near future, they face a competing aim to control its utilization. Even though current LLMs and agents can “interpret” open-ended prompts, understand the tasks requested, and act upon them, e.g., by generating artifacts or executing various subtasks based on such “understanding,” this skill is not accessible to the enterprise. This lack of understanding and natural-language native techniques hinders the possibility to “interpret” the prompts and implement effective controls over the tasks and usage of applications based on generative AI.

Therefore, existing techniques are not equipped to detect the task(s) carried in a prompt and/or apply controls before the prompt is sent and processed by an LLM. Consequently, enterprises lack a mechanism to control and restrict the usage of LLMs depending on the task(s) requested in a prompt. As a result, enterprises increasingly opt to prohibit the use of LLMs given their inability to exert controls to prevent certain tasks from being carried out using the LLM.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an environment for PPU-based task control deployments;

FIG. 4 illustrates an example architecture including a PPU configured for PPU-based task control deployments;

FIG. 5 illustrates an example of a task control system 500 that leverages the outputs of PPUs;

FIGS. 6A-6B illustrate an example of a task control system configured to manage task detection and usage control;

FIGS. 7A-7C illustrate an example of a task control system configured to manage task detection and usage control;

FIG. 8 illustrates an example of an output of a PPU; and

FIG. 9 illustrates an example simplified procedure for PPU-based task control in generative artificial intelligence, in accordance with one or more implementations described herein.

### DESCRIPTION OF EXAMPLE IMPLEMENTATIONS

### Overview

According to one or more implementations of the disclosure, a device may identify a type of task and its context indicated by a prompt sent by a user for input to a language model. The device may authorize the prompt for input to the language model based on the type of task and its context. The device may make a determination as to whether a response of the language model to the prompt is authorized to be returned to the user based on the response, the type of task, and its context. The device may prevent the response from being returned to the user when the determination indicates that the response is not authorized to be returned.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

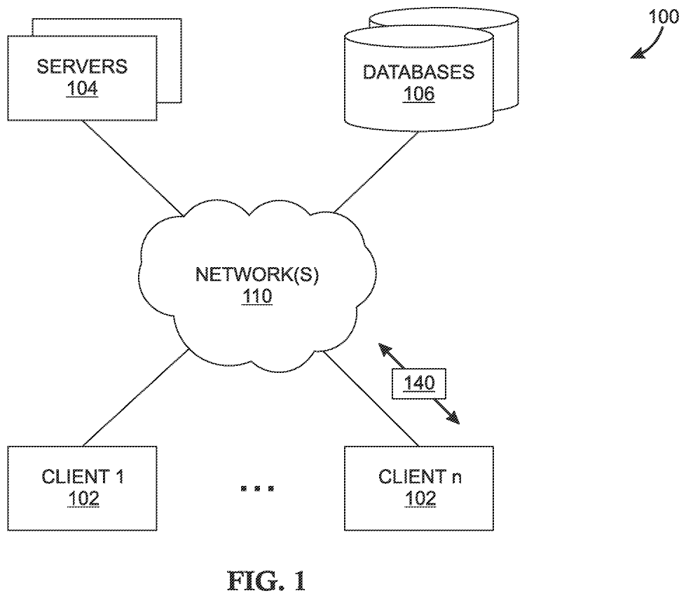

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

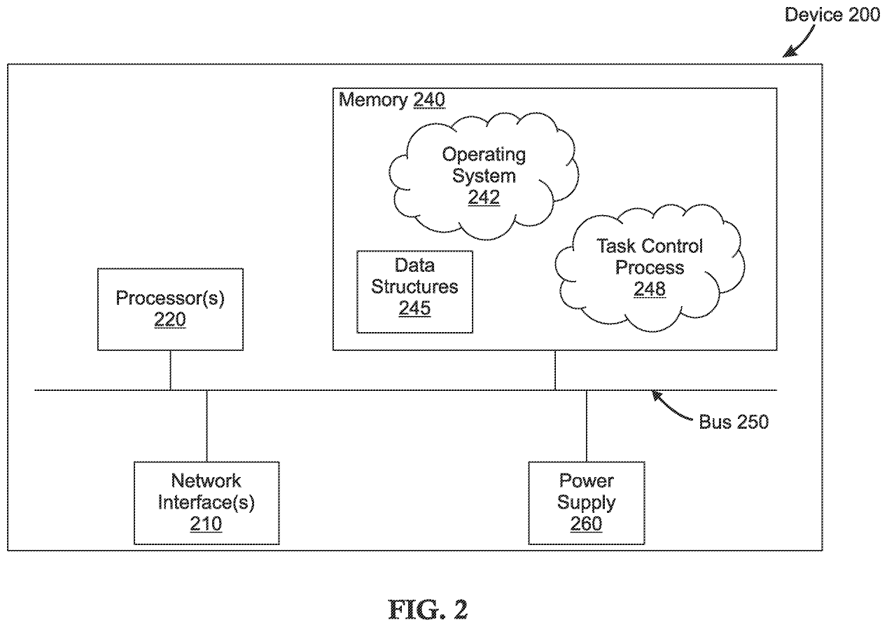

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise a task control process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, task control process 248 may include computer-executable instructions that, when executed by processor(s) 220, cause device 200 to perform the techniques described herein. To do so, in some implementations, task control process 248 may utilize machine learning. In general, machine learning is concerned with the design and the development of techniques that take as input empirical data (such as network statistics and performance indicators) and recognize complex patterns in these data.

In various implementations, task control process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that task control process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, task control process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, task control process 248 may use a generative model to generate synthetic network traffic based on existing user traffic to test how the network reacts. Example generative approaches can include, but are not limited to, generative adversarial networks (GANs), large language models (LLMs), other transformer models, and the like.

As noted above, although many enterprises aim to leverage generative AI, they lack the ability to control its utilization at a level that is acceptable to comfortably enable its adoption. Again, even though current LLMs and agents can “interpret” open-ended prompts, understand the tasks requested, and act upon them—e.g., by generating artifacts or executing various subtasks based on such “understanding”—this skill is not accessible to the enterprise. This lack of understanding and natural-language native techniques hinders the possibility to “interpret” the prompts and implement effective controls over the tasks and usage of applications based on generative AI. For instance, the Swiss Federal Administration has recently prohibited its workers from using LLMs in various cases, including translating CVs, entering existing software for debugging purposes, or summarizing specific report procedures. Clearly, this is not an isolated case since many companies and administrations across the globe are following a similar pattern.

In this regard, a challenge that enterprises are facing today is the lack of mechanisms to control and restrict the usage of LLMs depending on the task(s) requested in a prompt. Differently from existing techniques, which mainly focus on data security, regulatory compliance, and controls to prevent that Personally Identifiable Information (PII) or confidential information is sent to an LLM, the challenge for a growing number of enterprises resides in detecting the task(s) carried in a prompt and being able to apply controls before that prompt is sent and processed by an LLM.

### --Task Control in Generative Artificial Intelligence Based on Prompt Processing Units--

In contrast, the techniques described herein introduce a mechanism that is utilizable to semantically detect and extract the tasks from a prompt as well as their context, which could be part of the prompt itself (e.g. a copy paste of a CV, a link or a reference to a CV, parts of a set of documents retrieved through a RAG system, or through an agent connected to a database). Furthermore, a prompt augmented with additional context might be formulated in such a way that the input itself to an LLM is not sufficient to prevent certain tasks from being carried out using the LLM. Hence, the techniques described herein also introduce a mechanism to process the output of an LLM, to detect unauthorized tasks using the completions in addition to the inputs to an LLM.

More specifically, the techniques described herein tackle these deficiencies in existing systems by introducing a Prompt Processing Unit (PPU), which allows to characterize and distill key features from a prompt in a systematic manner. In addition, these techniques introduce task detection and usage controls that are based on such characterization. Further, the techniques described herein include the definition of task control policies using natural language, and the subsequent detection of violations to such controls at inference working in tandem with a PPU. Moreover, the techniques introduced herein may apply to the contents carried in the original prompt, to augmented context supplied as part of the prompting procedure, as well as to the responses provided by a generative AI model.

Illustratively, the techniques described herein may be performed by hardware, software, and/or firmware, such as in accordance with task control process 248, which may include computer executable instructions executed by the processor(s) 220 (or independent processor of the network interfaces 210) to perform functions relating to the techniques described herein. Further, they may be combined with post-processing methods to provide aggregated and/or historical visibility of prompt features and insights across an enterprise.

Specifically, according to various implementations, a device may identify a type of task and its context indicated by a prompt sent by a user for input to a language model. The device may authorize the prompt for input to the language model based on the type of task and its context. The device may make a determination as to whether a response of the language model to the prompt is authorized to be returned to the user based on the response, the type of task, and its context. The device may prevent the response from being returned to the user when the determination indicates that the response is not authorized to be returned.

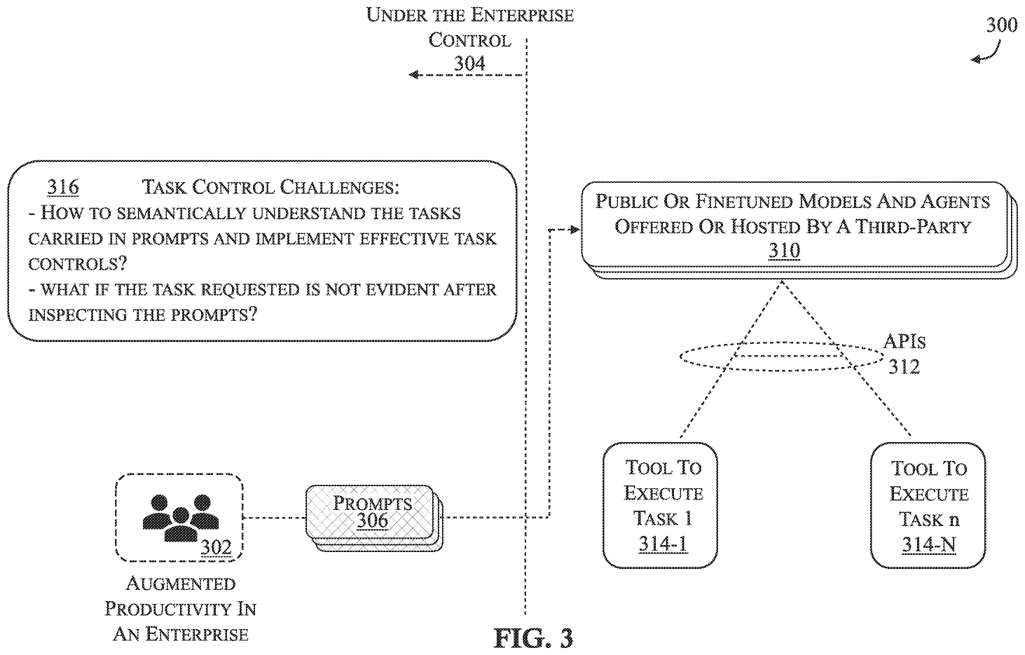

Operationally, FIG. 3 illustrates an example of an environment 300 for prompt processing unit (PPU)-based task control deployments, in accordance with one or more implementations described herein. In environment 300, the system may include an enterprise-controlled portion 304 via which prompts 306 are submitted (e.g., via a user chat interface or an API). The ability of users 302 to submit these prompts 306 may facilitate augmented productivity. For instance, sales, marketing, customer support, data analytics, engineering, product management, etc. may all utilize the prompts 306 to enhance their productivity.

Typically, the system may pass prompts 306 to a machine learning model 310 for processing and/or execution. For instance, machine learning model 310 may be a generative AI model, such as an LLM or other language and/or vision model. In some instances, machine learning model 310 may include a public or finetuned model and/or agents offered or hosted by a third party.

In addition, tools 314 (e.g., 314-1 . . . 314-N) for executing various tasks may be communicatively coupled (e.g., via APIs 312) to the machine learning model 310 and/or may be operable to participate in the execution of tasks specified in prompts 306.

Although many enterprises aim to leverage generative AI, they may also want to control its usage, including the responses received from machine learning model 310. Consequently, while the prompts 306, users 302, and/or a user/APIs 312 may be within the enterprise-controlled portion 304, an enterprise may be compelled to target additional understanding and implement task controls, hence enabling them to address the challenges 316. In particular, enterprises may need techniques to semantically detect and extract the tasks from a prompt as well as from any additional context provided as part of the prompt to the machine learning model 310 (e.g., a file attached).

Machine learning model 310 and/or tools 314 may be equipped to “interpret” open-ended prompts and act upon them by generating artifacts or executing various tasks based on such “understanding.” However, this skill is not accessible to an enterprise attempting to implement task controls within the enterprise-controlled portion 304. This lack of understanding and natural-language native techniques hinders the observation and comprehension of what are the tasks requested, or what additional data would be involved to complete such tasks, and thus, apply effective task controls before the prompts are proceeded by external entities.

However, these features may be enabled, and facilitated, within environment 300 utilizing prompt processing units (PPUs). Hence, environment 300 may be modified by incorporating a task control system that leverages PPUs. Such a system may be utilized to characterize and/or distill key features from prompts 306 in a systematic manner. The observability system may then leverage these characterizations to apply effective task controls before the prompts are processed by external entities.

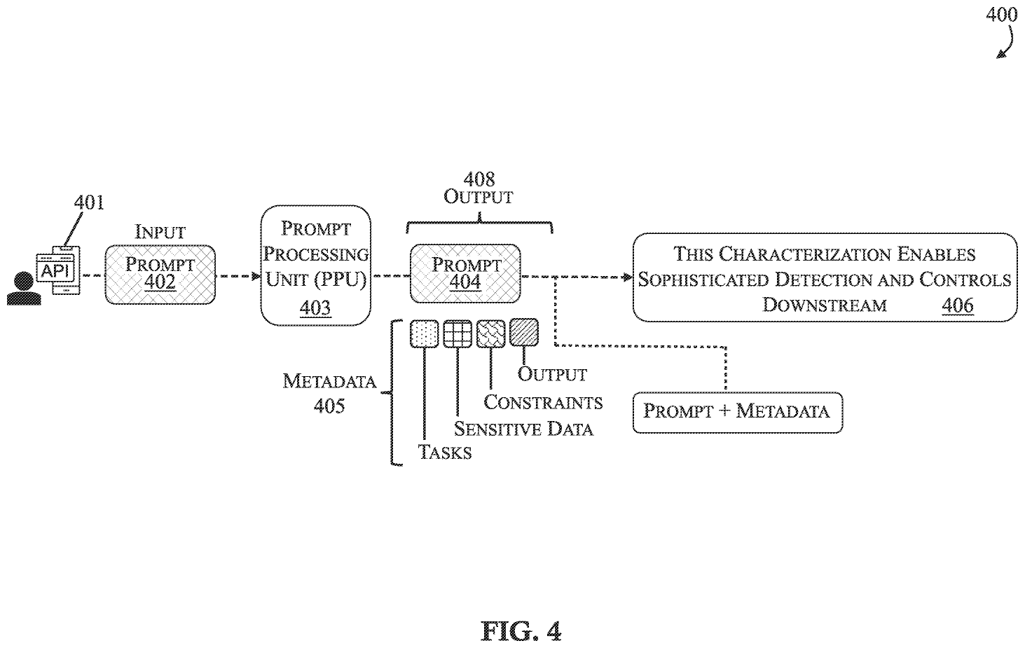

FIG. 4 illustrates an example architecture 400 including a prompt processing unit (PPU 403) configured for PPU-based task control deployments, in accordance with one or more implementations described herein. Architecture 400 may be a portion of a data control system that leverages the outputs of the PPU 403 to institute sophisticated task control, etc. Typically, architecture 400 may be implemented at the enterprise-controlled portion of the system, although other implementations provide for some or all of its components to be executed externally, as well.

In general, PPU 403 may be a highly efficient processing element that may receive a prompt 402 as an input (e.g., from a user chat interface or an API 401). PPU 403 may parse the prompt 402 and/or may detect a set of key features from prompt 402. For instance, PPU 403 may detect key features within prompt 402 such as the tasks requested, the sensitive data entailed to complete the tasks, any constraints applicable to complete the tasks, and/or the desired output upon completion of such tasks.

PPU 403 may also act as a transparent element, delivering the unmodified prompt 404 augmented with metadata 405 carrying the key features, such as those described above, as output 408. More specifically, a PPU 403 may systematically distill and characterize prompts, thereby enabling new and sophisticated controls downstream 406.

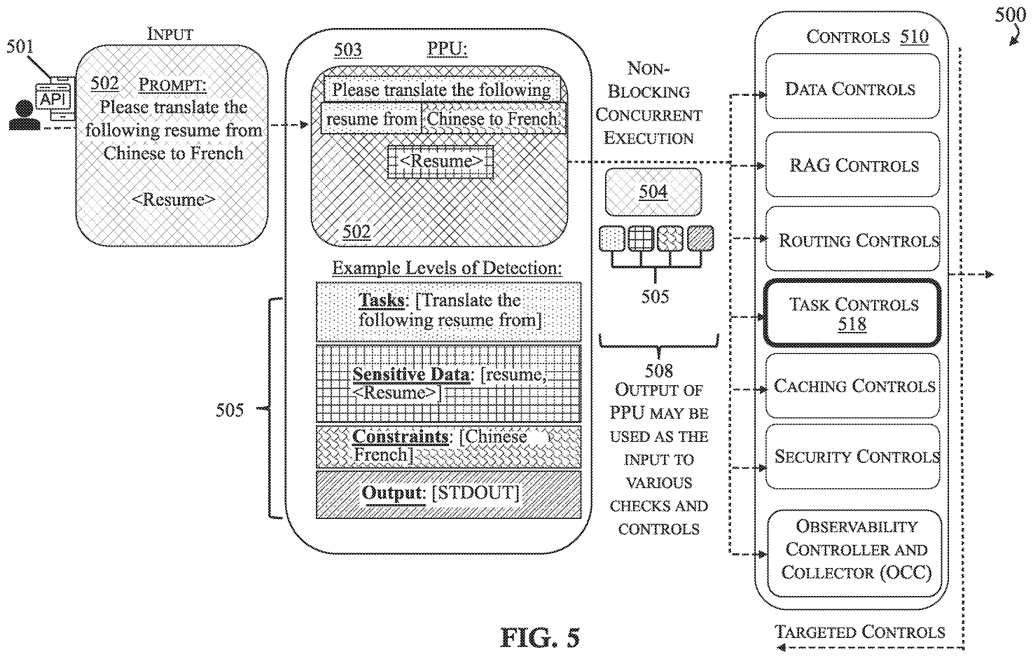

FIG. 5 illustrates an example of a task control system 500 that leverages the outputs of PPUs, in accordance with one or more implementations described herein. In task control system 500, an input prompt 502 (e.g., sent by a user in the HR department either using a chat interface or an API 501) may be processed by PPU 503. PPU 503 may detect key features in the input prompt 502 such as those outlined above. These features and/or other characterizing data may be packaged as metadata 505.

PPU 503 may generate an output 508 that makes available the output prompt 504 along with the prompt characterization (e.g., metadata 505) to various processes downstream. In various implementations, PPU 503 may fan-out the prompt and the corresponding metadata (e.g., output 508) to various controls (e.g., controls 510). These controls 510 may process the output of PPU 503 concurrently and in a non-blocking manner before the prompt is sent to any external entity. One such example of controls 510 includes task controls 518, which may be applied before input prompt 502/output prompt 504 is processed by external entities, in some implementations. Further examples of controls 510 include, but are not limited to, data controls, retrieval augmented generation (RAG) controls, routing controls, caching controls, security controls, observability controller and collector (OCC), or the like.

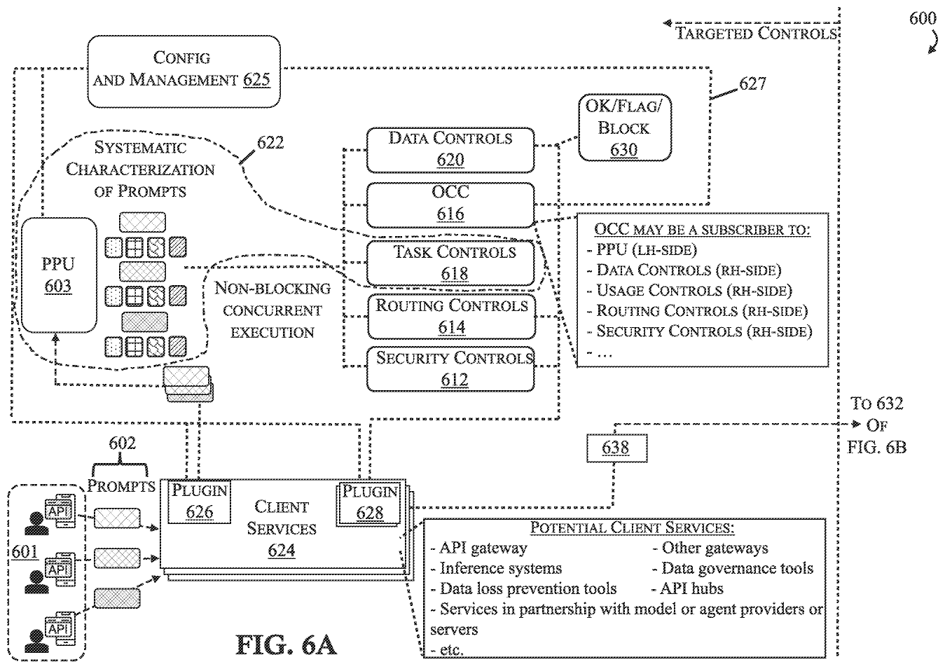

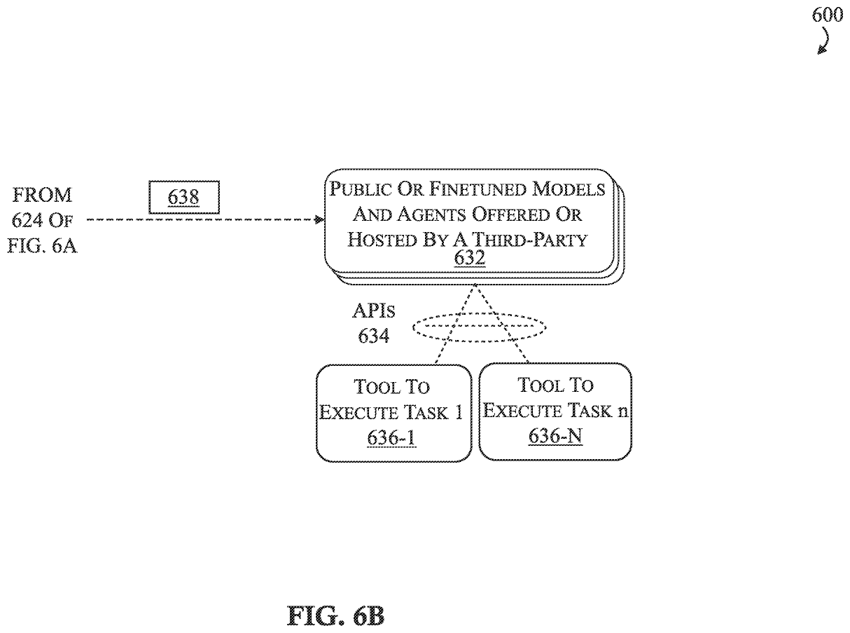

FIGS. 6A-6B illustrate an example of a task control system 600 configured to manage task detection and usage control, in accordance with one or more implementations described herein. For example, task control system 600 may be configured to manage task detection and usage control across various users and/or APIs 601 sending prompts 602 to potentially different models and/or agents offered or hosted by third-parties 632.

Various methods may be used to retain and exercise control before the prompts are sent to external entities. For example, an intermediate layer of control may be utilized, such as an API Gateway, other gateways, an inference system, a data governance tool, a data loss prevention (DLP) tool, a service in partnership with model or agent providers or servers, an API Hub, etc. Any of these intermediate elements of control may act as a client service 624 working in concert with element 622, which may comprise PPU 603 and task controls 618 working in tandem.

PPU 603 may interface with client service 624 through plugin(s) 626, which may be used to efficiently redirect the prompts 602 to PPU 603 along with additional metadata. Such metadata may comprise a nonce, the user ID, the tenant ID, and the App ID (e.g., identified through the API key used) associated to the various users of client service 624. In some implementations, such metadata might be sent by client service 624 directly to the corresponding controllers, e.g., data controls 620, observability controller and collector (e.g., OCC 616), task controls 618, routing controls 614, and/or security controls 612, thereby bypassing PPU 603.

A configuration and management module 625 may manage the configuration and/or management of plugin(s) 626, plugin(s) 628, PPU 603, and/or task controls 618 (e.g., via the interface 627). Such configuration may define task controls 618 as a subscriber of PPU 603 (e.g., on the left hand-side) as well as a publisher to OCC 616 and plugin(s) 628 (e.g., on the right hand-side). This may enable OCC 616 to not only provide visibility of an infringement of task control policies but also to collect logs and gain insights into the effectiveness of task control techniques, including insights into which type of infringements are mostly attempted. Indeed, the processing made by task controls 618 may result in detecting and reporting usage infringements as additional prompt metadata.

In various implementations, configuration and management module 625 may also configure other listeners to task controls 618, such as data controls 620, routing controls 614, or security controls 612, etc. to either trigger or override the outcome of certain controls depending on whether there is an infringement or not of the usage policy configured through configuration and management module 625.

In various implementations, one or more of plugin(s) 626 may be used, e.g., to handle various PPUs concurrently and potentially distribute the load across users, tenants, and/or applications, and/or ensure isolation among them. Alternatively, or additionally, the PPUs might be specialized elements, which may distill different properties from a prompt depending on the use case. Hence, various plugin(s) 626 may be used to segment and redirect prompts to the right PPUs. In addition, plugin(s) 628 may support mechanisms to indicate the need to reengineer the prompt, block it, and/or send feedback about the result to the corresponding user or process that issued the prompt.

The prompts for which there is not an infringement, and that successfully passed the checks and various controls, may be sent, at box 638, to the various public or finetuned models and/or agents offered or hosted by third-parties 632. As shown in FIGS. 6A-6B, such models may be part of larger systems, which may use various APIs 634 and tools 636 (636-1 . . . 636-N) to orchestrate, execute, and chain various tasks before responding to a query carried in a prompt.

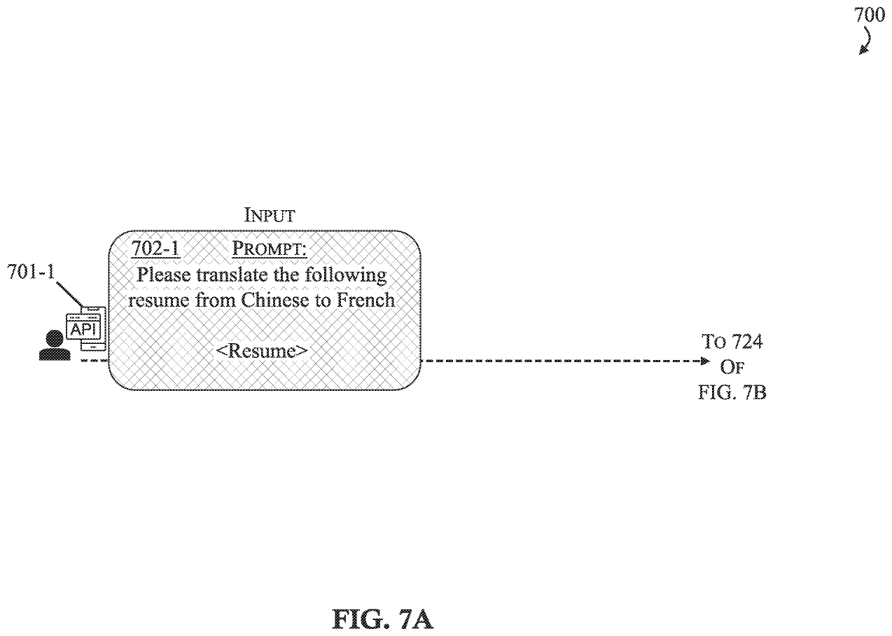

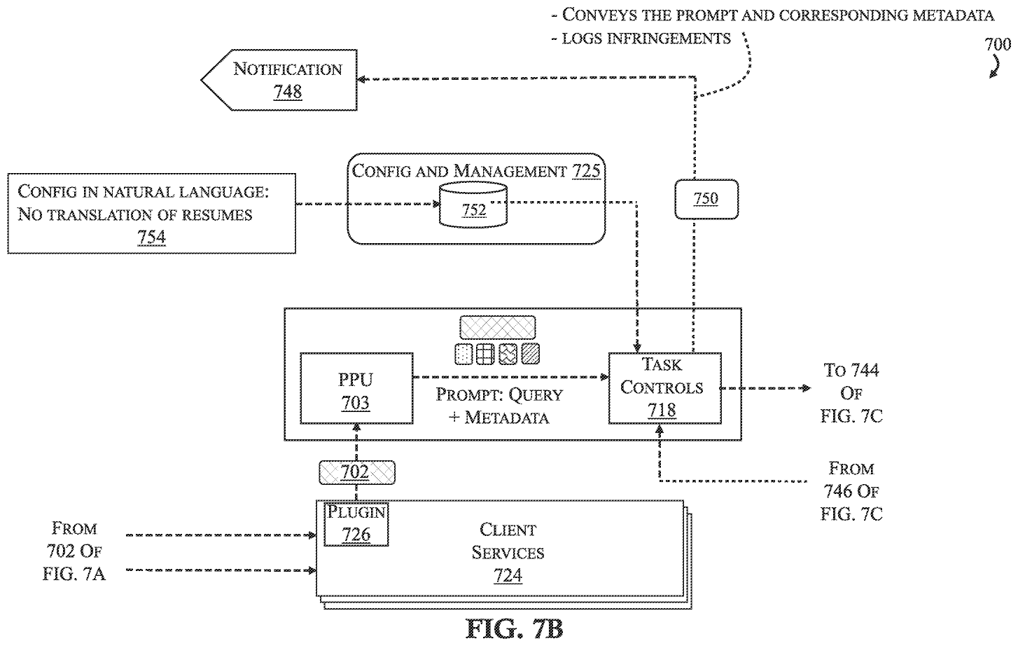

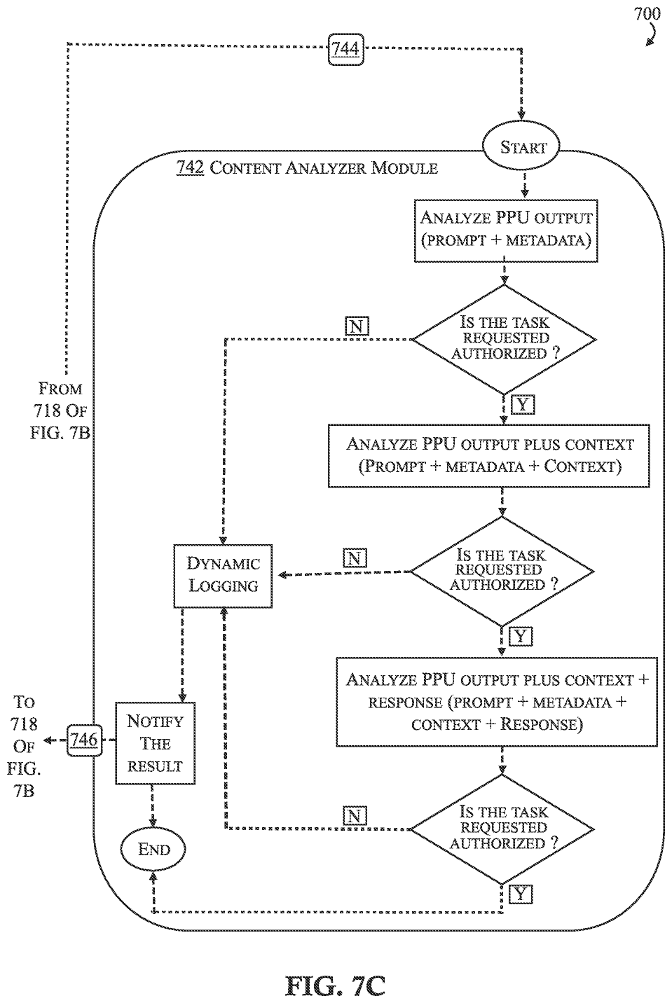

FIGS. 7A-7C illustrate an example of a task control system 700 configured to manage task detection and usage control, in accordance with one or more implementations described herein. In task control system 700, an input prompt 702 (e.g., sent by a user in the HR department either using a chat interface or an API 701) may be received at client service 724. The input prompt 702 may be sent to PPU 703 through plugin 726. PPU 703 may make the prompt characterization available to task controls 718.

In various implementations, the task control system 700 and/or the task controls 718 may include and/or utilize a content analyzer module 742 in step 744. The content analyzer module 742 may analyze the characterization of each prompt as supplied by PPU 703, and act upon such characterization using various steps. For instance, content analyzer module 742 may not enforce any usage policy at prompt level, but instead, it may analyze the task detected by PPU 703 to determine whether there is an infringement to a task control policy, such as policy 754, and log and notify such infringements whenever they occur.

More specifically, an administrator may configure a task control policy, such as policy 754 and store it in a policy database 752, which may be part of configuration and management module 725. In various implementations, an administrator may enter only policies describing unauthorized tasks, which may be configured using natural language, such as policy 754 in FIG. 7B: “No translation of resumes.” Hence, any task that is not within the unauthorized list may be carried out with the support of external ML models.

To this end, content analyzer module 742 might be trained or fine-tuned to acquire the specific skill of identifying whether there is an infringement to a task control policy, considering the task extracted from the prompts by PPU 703, any augmented context that might be supplied together with the original prompt, as well as the responses coming from external models (not depicted in FIGS. 7A-7C). The analysis can be performed leveraging different embedding layers along with similarity search techniques, and/or leveraging natural language inference (NLI) models pretrained and finetuned for this specific task. This capability may be trained and acquired in different ways. For instance, it may be supported by fine tuning and Reinforcement Learning with Human Feedback (RLHF).

In various implementations, content analyzer module 742 might analyze only the pair (prompt+metadata, task control policy), by leveraging the metadata generated by PPU. If an infringement is detected, infringement logs may be generated and reported through step 746, and subsequently generate a notification 748 in step 750. An example of a task control policy and a prompt that would infringe such policy may be:
Task Control policy defined in natural language: “No translation of resumes.”
Prompt: “Translate the following resume”<copy pasted resume>

In various instances, task controls 718 may have access to augmented retrieved context (e.g., through client services 724). In such instances, content analyzer module 742 may also be able to analyze the pairs (prompt+metadata+context, task control policy). Likewise, if an infringement is detected, infringement logs may be generated and reported through step 746, and an additional notification (e.g., notification 748) may be generated in step 750. An example of a task control policy and a more subtle prompt that would pass the first level control in content analyzer module 742, but would infringe the second level control are given below:
Task Control policy defined in natural language: “No translation of resumes.”
Prompt: “Translate all the files that contain a section related to coding skills.”
Context: RAG retrieved files from CVs

In some implementations, task controls 718 may also have access to the responses generated by external machine learning models (e.g., through client services 724). In such case, content analyzer module 742 may also analyze the pairs (prompt+metadata+LLM response, task control policy). Hence, if an infringement is detected, infringement logs may also be generated and reported through step 746 and an additional notification (e.g., notification 748) may be triggered in step 750. Another example of a task control policy and a prompt that would pass the first and/or the second level controls in the content analyzer module 742, but would infringe the third level control are given below:
Task Control policy defined in Natural Language: “No translation of resumes.”
Prompt: “Translate the contents in the following link to French <URL>.”
Response: <Translated CV>

In various implementations, task controls 718 may have access simultaneously to PPU 703, augmented retrieved context, and to the response generated by external machine learning models, through client services 724. Hence, content analyzer module 742 might be able to analyze the pairs (prompt+metadata, task control policy), (prompt+metadata+context, task control policy) as well as (prompt+metadata+LLM response, task control policy) incrementally. Thus, if an infringement is detected, infringement logs may be generated and reported through step 746, and an additional notification (e.g., notification 748) may be triggered in step 750. An example flow of this implementation is captured in content analyzer module 742 in FIG. 7C.

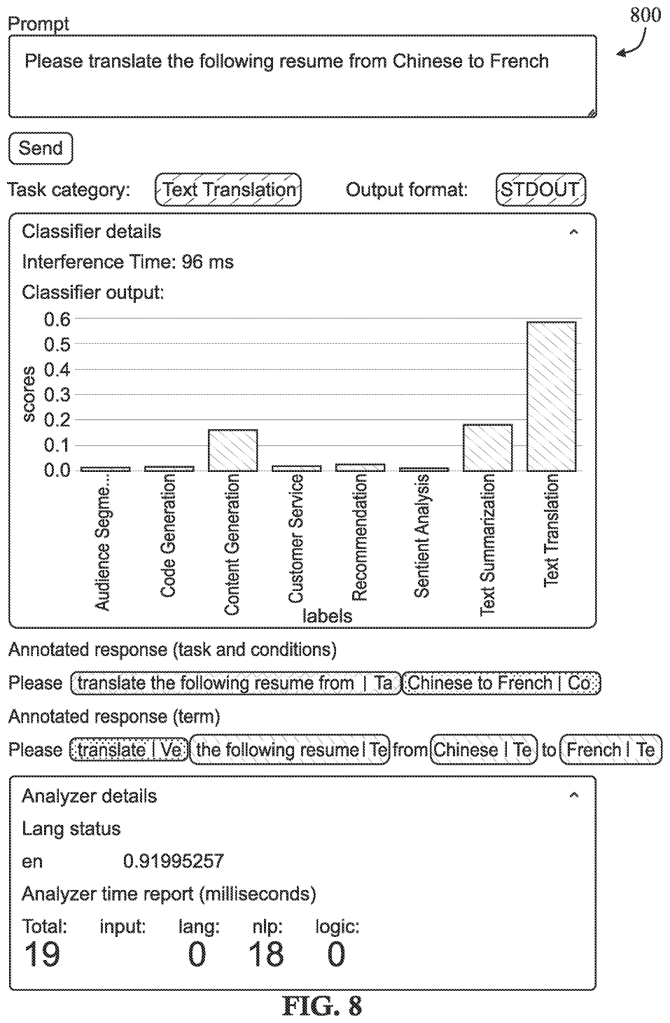

FIG. 8 illustrates an example of an output 800 of a PPU, in accordance with one or more implementations described herein. Output 800 may be an output of a PPU that is part of a utility that facilitates trustworthy and compliant generative AI deployments and utilization. Output 800 may include task detections which may be highly relevant for the task controls described herein.

Various non-limiting examples have been provided herein, however other possible techniques and/or implementations may apply as well. Moreover, the techniques introduced herein may support effective mechanisms to detect infringements to task control policies, and dynamically log and notify such infringements when they happen. For example, the content analyzer module (e.g., content analyzer module 742 in FIG. 7C) may be targeted toward the functionality described herein. This module doesn't need to generate poetry, write code, perform mathematical calculus, process images, or support multi-modal inputs. In practical terms, it can be a specifically trained element devoted only to do task detection and analysis.

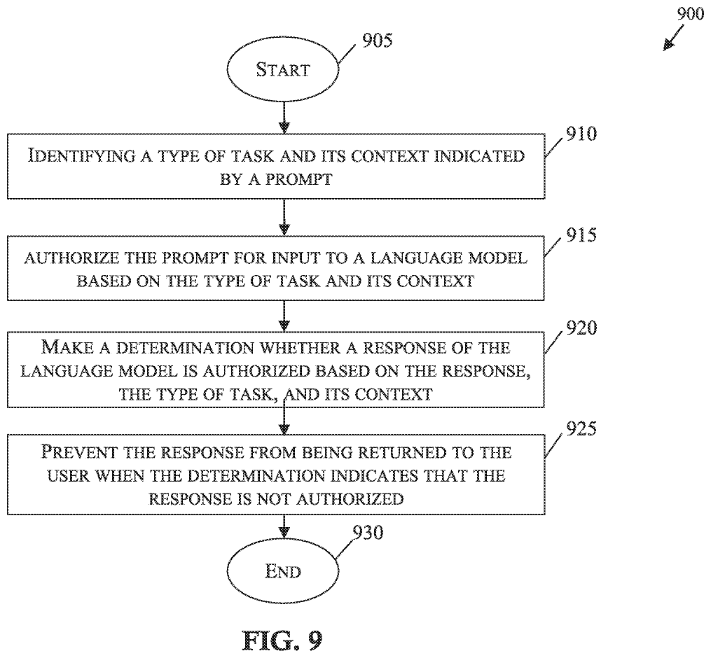

FIG. 9 illustrates an example simplified procedure for PPU-based task control in generative artificial intelligence, in accordance with one or more implementations described herein. For example, a non-generic, specifically configured device (e.g., device 200), may perform procedure 900 (e.g., a method) by executing stored instructions (e.g., task control process 248).

The procedure 900 may start at step 905, and continues to step 910, where, as described in greater detail above, the device (e.g., a controller, processor, etc.) may characterize a prompt to a language model. For example, the device may identify a type of task and/or its context as indicated by a prompt sent by a user for input to a language model. For instance, a prompt may be obtained from a user/API and parsed to generate a prompt characterization (e.g., by a PPU). The prompt characterization may include an indication of the type of task indicated and/or requested by the prompt. Likewise, context indicated and/or requested by the prompt may be identified. The context may include a file from a retrieval-augmented generation system.

At step 915, as detailed above, a device may authorize the prompt for input to the language model based on the type of task and/or its context. However, control over the prompt may be retained by an intermediate layer while it is subject to task control operations and/or prior to sending the prompt for input to the language model. For example, the prompt, may be held within an intermediate layer of control (e.g., that may be associated with and/or controlled by an individual and/or enterprise submitting the prompt), and may not be input to a language model and/or external entity until authorization for its input is completed (e.g., may be held while the prompt is parsed/processed, its types of tasks are identified, its context is identified, authorization determinations for the prompt are performed, etc.).

For example, the prompt may be held from submission to a language model while a determination is made as to whether the prompt is authorized for the input to the language model. This determination may be based on a comparison of the type of task and/or its context to a task control policy. In some instances, if the prompt, the type of task, and/or the context do not represent a task control policy, then procedure 900 may proceed to step 920.

Alternatively, or additionally, if execution of the prompt, the type of task, and/or the context would violate a task control policy, then the prompt may be blocked from being input to the language model. Further, if execution of the prompt, the type of task, and/or the context would violate a task control policy, then the prompt may be caused to be reengineered. This may include flagging the prompt, the type of task, and/or the context and/or notifying a user or administrator of a need to reengineer the prompt. In some instances, suggestions for reengineering the prompt to resolve the task control policy violation may be provided to the user and/or administrator as well.

At step 920, as detailed above, a device may make a determination as to whether a response of the language model to the prompt is authorized to be returned to the user based on the response, the type of task, and/or its context. Here, it may be presupposed that the prompt was authorized for input to the language model and/or that it was sent to the large language model for processing/completion. In instances where it was sent to the language model, a response of the language model to the prompt may be obtained and/or retained by an intermediate layer while making the determination as to whether the response of the language model to the prompt is authorized to be returned to the user.

The response may be analyzed and compared (independently or in conjunction with the prompt, the type of task, and/or its context) to a task control policy to determine if it is authorized. In other instances, an expected response from the language model may be modeled or estimated and that model or estimate compared (independently or in conjunction with the prompt, the type of task, and/or its context) to a task control policy to determine if it is authorized. At this point, the response may not yet have been provided to the entity that submitted the prompt.

At step 925, as detailed above, the device may prevent the response from being returned to the user when the determination indicates that the response is not authorized to be returned. For example, when providing the response to the user represents a task control policy violation, the user may be prevented from receiving the response. Alternatively, the response may be provided to the prompting entity responsive to a determination that providing the response to the prompting entity does not constitute a task control policy violation.

Throughout procedure 900, task control policy violations associated with one or more prompts may be dynamically logged. Then, characterizations of task control policy violations across a plurality of prompts may be generated based on these logs. In addition, notifications may be utilized throughout to notify users, administrators, control systems, etc. of the results of each step of procedure 900 and/or its underlying operations/determinations.

Procedure 900 then ends at step 930.

It should be noted that while certain steps within procedure 900 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce prompt processing units (PPUs) for a large language model (LLM)-based system that are able to identify a task requested by a prompt and apply usage controls accordingly. As such, these techniques may facilitate the characterization and distillation of key features from a prompt in a systematic manner. In addition, these techniques introduce task detection and usage controls that are based on such characterization. Further, the techniques described herein include the definition of task control policies using natural language, and the subsequent detection of violations to such controls at inference working in tandem with a PPU. Moreover, the techniques introduced herein may apply to the contents carried in the original prompt, to augmented context supplied as part of the prompting procedure, as well as to the responses provided by a generative AI model.

While there have been shown and described illustrative implementations that provide for task control in generative AI based on PPUs, it is to be understood that various other adaptations and modifications may be made within the spirit and scope of the implementations herein. For example, while certain implementations are described herein with respect to using certain elements, modules, components, architectures, etc. for the purposes of task control in generative AI based on PPUs, the elements, modules, components, architectures, etc. are not limited as such and may be used for other functions, in other arrangements, in other functional distributions, in other implementations, etc.

In addition, while certain types of metadata and data types/categories such as tasks, sensitive data, policies, and outputs are shown, other suitable metadata and data types/categories, etc. may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method.

For example, the components and/or elements may be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, a type of task and its context indicated by a prompt sent by a user for input to a language model;
authorizing, by the device, the prompt for input to the language model based on the type of task and its context;
making, by the device, a determination as to whether a response of the language model to the prompt is authorized to be returned to the user based on the response, the type of task, and its context; and
preventing, by the device, the response from being returned to the user when the determination indicates that the response is not authorized to be returned.

2. The method as in claim 1, wherein control over the prompt is retained by an intermediate layer prior to sending the prompt to its input to the language model.

3. The method as in claim 1, wherein control over the response of the language model to the prompt is retained by an intermediate layer while making the determination as to whether the response of the language model to the prompt is authorized to be returned to the user.

4. The method as in claim 1, further comprising:
making a determination as to whether the prompt is authorized for the input to the language model based on a comparison of the type of task and its context to a task control policy.

5. The method as in claim 4, further comprising:
blocking the prompt from being input to the language model when the type of task and its context violate the task control policy.

6. The method as in claim 4, further comprising:
causing the prompt to be reengineered prior to being input to the language model when the type of task and its context violate the task control policy.

7. The method as in claim 1, further comprising:
logging a task control policy violation associated with the prompt.

8. The method as in claim 1, further comprising:
generating, based on logs of task control policy violations, characterizations of task control policy violations across a plurality of prompts.

9. The method as in claim 1, further comprising:
parsing the prompt to generate a prompt characterization, wherein the prompt characterization includes an indication of the type of the task.

10. The method as in claim 1, wherein the context includes a file from a retrieval-augmented generation system.

11. An apparatus, comprising:
one or more network interfaces;
a processor coupled to the one or more network interfaces and configured to execute one or more processes; and
a memory configured to store a process that is executable by the processor, the process when executed configured to:
identify a type of task and its context indicated by a prompt sent by a user for input to a language model;
authorize the prompt for input to the language model based on the type of task and its context;
make a determination as to whether a response of the language model to the prompt is authorized to be returned to the user based on the response, the type of task, and its context; and
prevent the response from being returned to the user when the determination indicates that the response is not authorized to be returned.

12. The apparatus as in claim 11, wherein control over the prompt is retained by an intermediate layer prior to sending the prompt to its input to the language model.

13. The apparatus as in claim 11, wherein control over the response of the language model to the prompt is retained by an intermediate layer while making the determination as to whether the response of the language model to the prompt is authorized to be returned to the user.

14. The apparatus as in claim 11, the process when executed further configured to:
make a determination as to whether the prompt is authorized for the input to the language model based on a comparison of the type of task and its context to a task control policy.

15. The apparatus as in claim 14, the process when executed further configured to:
block the prompt from being input to the language model when the type of task and its context violate the task control policy.

16. The apparatus as in claim 14, the process when executed further configured to:
cause the prompt to be reengineered prior to being input to the language model when the type of task and its context violate the task control policy.

17. The apparatus as in claim 11, the process when executed further configured to:
log a task control policy violation associated with the prompt.

18. The apparatus as in claim 11, the process when executed further configured to:
generate, based on logs of task control policy violations, characterizations of task control policy violations across a plurality of prompts.

19. The apparatus as in claim 11, the process when executed further configured to:
parse the prompt to generate a prompt characterization, wherein the prompt characterization includes an indication of the type of the task.

20. A tangible, non-transitory, computer-readable medium storing program instructions that cause a device to execute a process comprising:
identifying a type of task and its context indicated by a prompt sent by a user for input to a language model;
authorizing the prompt for input to the language model based on the type of task and its context;
making a determination as to whether a response of the language model to the prompt is authorized to be returned to the user based on the response, the type of task, and its context; and
preventing the response from being returned to the user when the determination indicates that the response is not authorized to be returned.
